(19) United States
(12) Patent Application Publication
(10) Pub. No.: US 2026/0133447 A1
(43) Pub. Date: May 14, 2026

(54) PHASE MODULATION APPARATUS

(71) Applicant: SONY SEMICONDUCTOR SOLUTIONS CORPORATION, KANAGAWA (JP)

(72) Inventor: TSUYOSHI OKAZAKI, KANAGAWA (JP)

(21) Appl. No.: 19/118,966

(22) PCT Filed: Sep. 19, 2023
(86) PCT No.: PCT/JP2023/033836

§ 371 Date: Apr. 7, 2025

(30) Foreign Application Priority Data
Oct. 13, 2022 (JP) 2022-164784

(51) Int. Cl. G02F 1/133

(52) U.S. Cl. CPC G02F 1/13306; G02F 2203/50

(57) ABSTRACT

A phase modulation apparatus according to an embodiment of the present disclosure includes: a phase modulation unit including a plurality of pixels, the phase modulation unit being configured to modulate a phase of light from a light source; and a generation section configured to generate first data and second data on a basis of a phase pattern, the first data being related to a phase modulation amount for each of the pixels in a first phase modulation range that is within a range of the phase modulation amount, the second data being related to the phase modulation amount for each of the pixels in a second phase modulation range that is within the range of the phase modulation amount. The phase modulation unit is configured to modulate the phase of the light from the light source on a basis of the first data, and modulate the phase of the light from the light source on a basis of the second data.

### TECHNICAL FIELD

The present disclosure relates to a phase modulation apparatus.

### BACKGROUND ART

There has been proposed an apparatus that includes a phase-modulation-type spatial modulation element, generates three diffraction patterns for each projection image, and reduces speckle with use of the three diffraction patterns (PTL 1).

### Citation List

### Patent Literature

PTL 1: Japanese Unexamined Patent Application Publication No. 2021-108458

### SUMMARY OF THE INVENTION

A phase modulation apparatus is desired to improve image quality.

It is desirable to provide a phase modulation apparatus that makes it possible to suppress a decrease in image quality.

A phase modulation apparatus according to an embodiment of the present disclosure includes: a phase modulation unit including a plurality of pixels, the phase modulation unit being configured to modulate a phase of light from a light source; and a generation section configured to generate first data and second data on a basis of a phase pattern, the first data being related to a phase modulation amount for each of the pixels in a first phase modulation range that is within a range of the phase modulation amount, the second data being related to the phase modulation amount for each of the pixels in a second phase modulation range that is within the range of the phase modulation amount. The phase modulation unit is configured to modulate the phase of the light from the light source on a basis of the first data, and modulate the phase of the light from the light source on a basis of the second data.

### BRIEF DESCRIPTION OF DRAWINGS

FIG. 1 is a diagram illustrating an example of a schematic configuration of a phase modulation apparatus according to an embodiment of the present disclosure.

FIG. 2 is an explanatory diagram of a configuration example of a pixel section of a phase modulation unit according to the embodiment of the present disclosure.

FIG. 3 is an explanatory graph of a relationship between a phase modulation amount and a voltage applied to a pixel of the phase modulation unit according to the embodiment of the present disclosure.

FIG. 4 is a graph illustrating an example of the relationship between the phase modulation amount and the voltage applied to the pixel of the phase modulation unit according to the embodiment of the present disclosure.

FIG. 5 is a timing chart illustrating an operation example of the phase modulation apparatus according to the embodiment of the present disclosure.

FIG. 6 is a graph illustrating an example of a relationship between a phase modulation amount and a voltage applied to a pixel of a phase modulation unit according to Modification Example 1 of the present disclosure.

FIG. 7 is a timing chart illustrating an operation example of a phase modulation apparatus according to Modification Example 2 of the present disclosure.

### MODES FOR CARRYING OUT THE INVENTION

Hereinafter, description is given in detail of an embodiment of the present disclosure with reference to the drawings. It is to be noted that the description is given in the following order.

### 1. Embodiment

### 2. Modification Examples

2-1. Modification Example 1
2-2. Modification Example 2
2-3. Modification Example 3
2-4. Modification Example 4

### 1. Embodiment

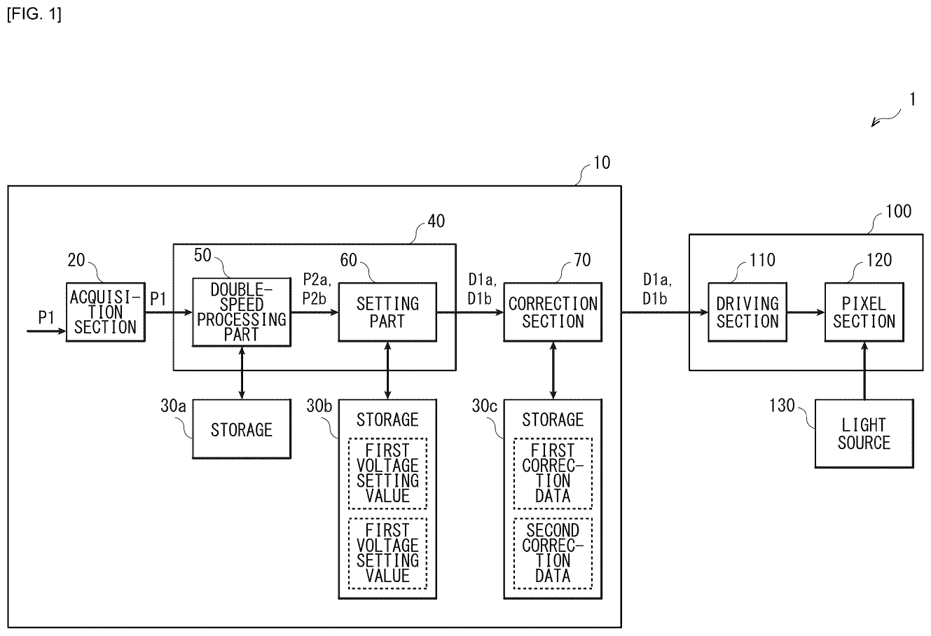

FIG. 1 is a diagram illustrating an example of a schematic configuration of a phase modulation apparatus according to an embodiment of the present disclosure. A phase modulation apparatus 1 is an apparatus configured to modulate a phase of light. The phase modulation apparatus 1 controls the phase of the light by utilizing a liquid crystal device. The phase modulation apparatus 1 may be a spatial light modulator (Spatial Light Modulator (SLM)), and control a wavefront of the light to output light of any pattern.

The phase modulation apparatus 1 is, for example, a spatial light modulator including liquid crystal on silicon (LCOS). The phase modulation apparatus 1 is applicable to various displays and optical apparatuses. The phase modulation apparatus 1 may be applied to, for example, a 3D displaying apparatus, a laser processing apparatus, a fundus examination apparatus, and an astronomical observation apparatus.

As illustrated in FIG. 1, the phase modulation apparatus 1 includes a data processing unit 10 and a phase modulation unit 100. The data processing unit 10 is configured to execute data processing. The data processing unit 10 may include, for example, a processor and a memory (such as a ROM or a RAM), and perform the data processing (information processing) on the basis of a program. The data processing unit 10 may be referred to as a signal processing unit (a signal processing circuit) configured to execute signal processing.

The data processing unit 10 is also a control unit, and is configured to control each component of the phase modulation apparatus 1. For example, the data processing unit 10 may supply a signal that controls the phase modulation unit 100 to the phase modulation unit 100 to thereby control an operation of the phase modulation unit 100.

The phase modulation unit 100 includes a device configured to modulate a phase of incident light. The phase modulation unit 100 is, for example, an LCOS panel. The phase modulation unit 100 is a liquid crystal phase modulation unit, and controls the phase of the light from a light source 130 by utilizing liquid crystal. The light source 130 is configured to radiate the light to the phase modulation unit 100. For example, the light source 130 may generate laser light and output the laser light to the outside.

The phase modulation apparatus 1 may cause the phase modulation unit 100 to diffract the light from the light source 130 to thereby control a wavefront of the light. It is to be noted that the phase modulation unit 100 may be a transmissive liquid crystal device or a reflective liquid crystal device. The phase modulation apparatus 1 may include the light source 130.

The phase modulation unit 100 includes a pixel section 120 and a driving section 110. The pixel section 120 includes a plurality of pixels. The driving section 110 is configured to drive each pixel of the pixel section 120. The driving section 110 may be a driver (a driving circuit), and control an operation of each pixel. For example, the driving section 110 is configured to control a voltage to each pixel of the pixel section 120. The driving section 110 may supply a voltage for driving each pixel to the relevant pixel, to thereby control phase modulation to be performed by the relevant pixel.

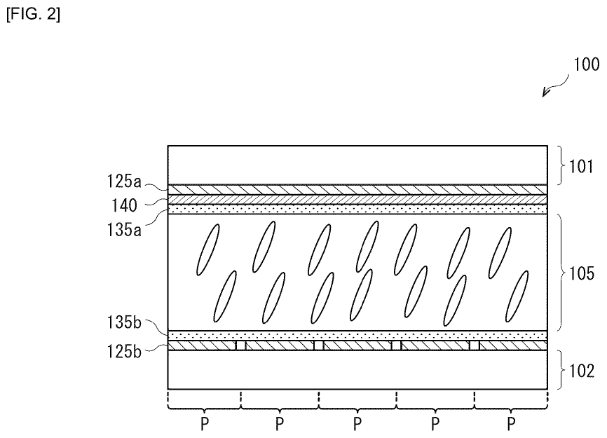

FIG. 2 is an explanatory diagram of a configuration example of the pixel section of the phase modulation unit according to the present embodiment. The phase modulation unit 100 includes a plurality of pixels P, and is configured to control the phase of the light for each pixel P. In the pixel section 120 of the phase modulation unit 100, the plurality of pixels P is provided in a two-dimensional manner. As illustrated in FIG. 2, the phase modulation unit 100 includes a first substrate 101, a second substrate 102, and a liquid crystal layer 105.

The first substrate 101 and the second substrate 102 are fixed with a non-illustrated sealing material with the liquid crystal layer 105 interposed therebetween. The first substrate 101 and the second substrate 102 that are in pair are disposed to be spaced apart from each other in a stacking direction.

The first substrate 101 is a transparent substrate that transmits light, and includes, for example, a glass substrate. The first substrate 101 is provided with a first electrode 125a. The second substrate 102 is disposed to be opposed to the first substrate 101.

The second substrate 102 includes, for example, a glass substrate or a semiconductor substrate (e.g., a silicon substrate). The second substrate 102 is provided with a second electrode 125b. The second electrode 125b is disposed to be opposed to the first electrode 125a with a portion of the liquid crystal layer 105 interposed therebetween.

The first electrode 125a is a transparent electrode, and includes, for example, indium tin oxide (ITO). The first electrode 125a is an electrode common to the plurality of pixels P, and may be also referred to as a counter electrode (or a common electrode).

The second electrode 125b includes, for example, a transparent material such as ITO. It is to be noted that the second electrode 125b may include another metal material such as aluminum (Al). The second electrode 125b is an electrode provided for each pixel P, and may be also referred to as a pixel electrode. Further, wiring and a device such as a transistor are formed in the second substrate 102. The second substrate 102 may be provided with the driving section 110 that drives each pixel P.

The liquid crystal layer 105 is a layer including a plurality of liquid crystal molecules, and is provided between the first substrate 101 and the second substrate 102. The liquid crystal layer 105 is sealed between the first substrate 101 and the second substrate 102 with the sealing material. The liquid crystal molecules of the liquid crystal layer 105 having dielectric anisotropy respond to a voltage applied between the first electrode 125a and the second electrode 125b, which makes it possible to control an orientation of the liquid crystal molecules.

The phase modulation unit 100 further includes an antireflection film 140 and an orientation film 135 (in FIG. 2, a first orientation film 135a and a second orientation film 135b). The antireflection film 140 includes, for example, a metal oxide. In the example illustrated in FIG. 2, the antireflection film 140 is provided between the first electrode 125a and the first orientation film 135a, and reduces (suppresses) reflection. The antireflection film 140 may be provided between the second electrode 125b and the second orientation film 135b. It is to be noted that the antireflection film 140 may not be provided in the phase modulation unit 100.

The orientation film 135 may cause the liquid crystal molecules of the liquid crystal layer 105 to be oriented in a specific direction. The orientation film 135 is a film (a layer) configured to control the orientation of the liquid crystal molecules. The orientation film 135 is configured by, for example, a film (an oblique vapor deposition film) formed by oblique vapor deposition of silicon oxide, or a polyimide film subjected to orientation processing such as rubbing.

In the example illustrated in FIG. 2, the first orientation film 135a is located between the liquid crystal layer 105 and the first electrode 125a, and is provided on the first electrode 125a. The second orientation film 135b is located between the liquid crystal layer 105 and the second electrode 125b, and is provided on the second electrode 125b. The liquid crystal molecules of the liquid crystal layer 105 are held in an inclined state by the first orientation film 135a and the second orientation film 135b. That is, the liquid crystal molecules of the liquid crystal layer 105 are each given a predetermined pretilt angle (inclination angle).

In the phase modulation unit 100, an electric field in the liquid crystal layer 105 changes in accordance with a voltage supplied between the first electrode 125a and the second electrode 125b, which changes the orientation of the liquid crystal molecules. The orientation of the liquid crystal molecules may be adjusted for each pixel P by controlling the voltage supplied to the second electrode 125b of the relevant pixel P to thereby change a refractive index and an optical path length.

Light incident on each pixel P of the phase modulation unit 100 is phase-modulated in accordance with an inclination amount of the liquid crystal molecules of the relevant pixel P before being outputted. The phase modulation unit 100 causes each pixel P to generate a different phase delay with respect to the incident light, enabling propagation of light having a desired wavefront.

The data processing unit 10 illustrated in FIG. 1 includes an acquisition section 20, storages 30a to 30c, a generation section 40, and a correction section 70. The acquisition section 20 is configured to acquire a phase pattern related to a phase modulation amount. The phase pattern is data on the phase modulation amount for each pixel P of the phase modulation unit 100. The phase pattern is data on a distribution of the phase modulation amounts to be set in the phase modulation unit 100, and may be also referred to as phase distribution data. The phase pattern is also referred to as a diffraction pattern.

For example, the phase pattern is generated by performing a light propagation calculation with image data on an image to be displayed. The phase modulation amount for each pixel P necessary to display (reproduce) an image (e.g., a hologram image) based on the image data may be calculated, and a phase pattern related to the phase modulation amount for each pixel P may be generated. The phase pattern is a computer-generated hologram (CGH) pattern.

The acquisition section 20 acquires the phase pattern of each frame of an image (a picture). The phase pattern is a signal indicating the phase modulation amount for each pixel P in a frame period, and may be also referred to as a picture signal indicating the phase modulation amount for each pixel P. In the example illustrated in FIG. 1, the acquisition section 20 sequentially receives phase patterns P1 of respective frames.

It is to be noted that the phase modulation apparatus 1 may generate the phase pattern P1, or the acquisition section 20 may acquire the phase pattern P1 generated by an external apparatus. The acquisition section 20 may be also referred to as an input section that receives the phase pattern P1 (the diffraction pattern) for each frame in a predetermined cycle.

The storages 30a to 30c each include, for example, a non-volatile memory, and each store (record) a program and data. The storages 30a to 30c may accommodate various types of information, such as a program and data to be used to control each component of the phase modulation apparatus 1. The storages 30a to 30c are each a recording medium such as a semiconductor memory or a hard disk. It is to be noted that all or a portion of the storages 30a to 30c may be integrally formed.

The generation section 40 is configured to generate, on the basis of the phase pattern, data (referred to as setting data) on the phase modulation amount for each pixel P in a subframe. Setting data DI is data on the distribution of the phase modulation amounts to be set in the phase modulation unit 100 for the subframe, and is data on a magnitude of the voltage (a potential difference) to be supplied between the electrodes of each pixel P of the phase modulation unit 100. The generation section 40 is configured to generate a plurality of pieces of the setting data DI corresponding to respective subframes in one frame for each phase pattern P1 of the one frame.

The generation section 40 may generate the setting data D1 for each subframe, and output the setting data D1 to the phase modulation unit 100. The generation section 40 generates, for example, setting data D1a and setting data D1b. The setting data D1a is related to the phase modulation amount for each pixel P in a first phase modulation range that is within a range of the phase modulation amount settable in the phase modulation unit 100. The setting data D1b is related to the phase modulation amount for each pixel in a second phase modulation range that is within the range of the phase modulation amount settable in the phase modulation unit 100. The generation section 40 generates the setting data Dla and the setting data D1b for each phase pattern P1 of the frame, and supplies the setting data Dla and the setting data D1b to the phase modulation unit 100 via the correction section 70.

As an example, the generation section 40 includes a double-speed processing part 50 and a setting part 60, as illustrated in FIG. 1. The double-speed processing part 50 is configured to generate and output a phase pattern P2 of the subframe. The double-speed processing part 50 may perform processing of dividing the phase pattern P1 acquired by the acquisition section 20 into the respective phase patterns P2 of a plurality of subframes resulting from dividing one frame.

The double-speed processing part 50 outputs the plurality of phase patterns P2 having the same phase distribution as that of the phase pattern P1. The double-speed processing part 50 may be considered as performing double-speed processing on the phase pattern and outputting the phase pattern subjected to the double-speed processing.

As an example, each frame is divided into a first subframe and a second subframe. In the example illustrated in FIG. 1, the double-speed processing part 50 may output, to the setting part 60, a phase pattern P2a of the first subframe of the frame and a phase pattern P2b of the second subframe of the frame.

The storage 30a is configured to store the phase pattern. The storage 30a receives the phase pattern P1 of each frame from the acquisition section 20. The storage 30a may be a frame memory, and hold the phase pattern P1 on a frame-by-frame basis. The double-speed processing part 50 of the generation section 40 controls writing of data into the storage 30a and reading of data from the storage 30a.

For example, the double-speed processing part 50 generates the phase pattern P2a and the phase pattern P2b by, for example, performing an operation of repeatedly reading, in a period half of a period of one frame, the phase pattern P1 stored in the storage 30a. The phase patterns P2a and P2b of the subframes are sequentially generated at a frame rate twice the frame rate, and outputted to the setting part 60. The phase patterns P2a and P2b are both data indicating the same phase distribution as that of the phase pattern P1.

The setting part 60 is configured to set a set range of the phase modulation amount for the subframe. As an example, the setting part 60 is configured to change a phase modulation range for the subframe by, for example, changing a reference voltage (e.g., a lower-limit value, a median value, or an upper-limit value of a set range of the voltage) to be supplied to the pixel P of the phase modulation unit 100 for the subframe.

For the respective phase patterns P2 of the plurality of subframes in the frame, the setting part 60 performs processing of shifting the reference voltage (e.g., a lower-limit value (a minimum value) of the voltage), i.e., processing of adding an offset value to the reference voltage. The setting part 60 shifts the set range of the phase modulation amount for each subframe by shifting the reference voltage. In this way, the setting part 60 may perform the shift processing to thereby generate the setting data D1 for each subframe indicating a different phase modulation range, while maintaining a difference in the phase modulation amount between the respective pixels indicated by the phase pattern P1 (and the phase pattern P2).

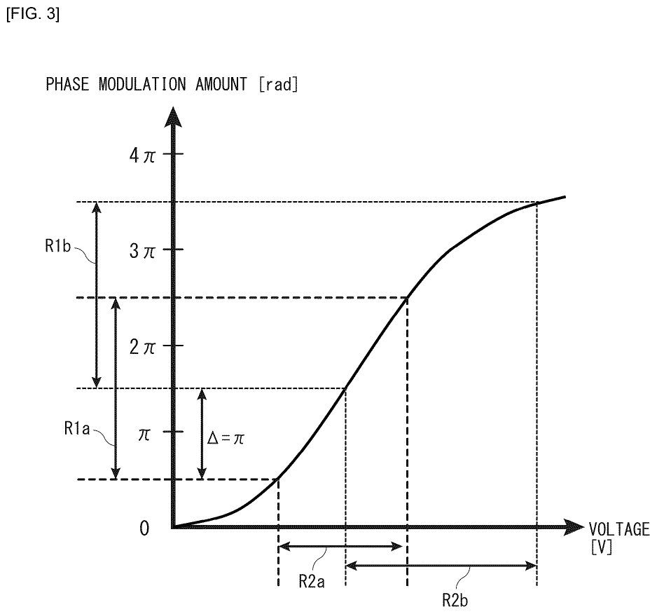

FIG. 3 is an explanatory graph of a relationship between the phase modulation amount and the voltage applied to the pixel of the phase modulation unit according to the present embodiment. In FIG. 3, the applied voltage is represented by a horizontal axis, and the phase modulation amount is represented by a vertical axis. In the example illustrated in FIG. 3, the setting part 60 generates the setting data D1a on a voltage range R2a for a first phase modulation range R1a on the basis of the phase pattern P2a of the first subframe.

The setting part 60 further generates the setting data D1b on a voltage range R2b for a second phase modulation range R1b on the basis of the phase pattern P2b of the second subframe. The second phase modulation range R1b is a phase modulation range shifted from the first phase modulation range Rla. The second phase modulation range R1b is a range resulting from shifting an entirety of the first phase modulation range Rla. Further, the voltage range R2b is a voltage range shifted from the voltage range R2a.

The storage 30b illustrated in FIG. 1 is configured to store a voltage setting value that is data on the reference voltage to be supplied to the pixel P. The storage 30b may hold a plurality of voltage setting values. The setting part 60 of the generation section 40 controls writing of data into the storage 30b and reading of data from the storage 30b. For example, the setting part 60 performs processing of shifting the reference voltage and the phase modulation range, in accordance with the voltage setting value stored in the storage 30b.

In the example illustrated in FIG. 1, the storage 30b stores a first voltage setting value indicating a reference voltage V1 serving as a lower-limit value for the first phase modulation range R1a illustrated in FIG. 3. The storage 30b further stores a second voltage setting value indicating a reference voltage V2 serving as a lower-limit value for the second phase modulation range R1b.

The setting part 60 performs processing of shifting the respective phase modulation ranges and voltage ranges for the phase patterns P2a and P2b in accordance with the first voltage setting value and the second voltage setting value stored in the storage 30b, and generates the setting data D1a and the setting data D1b. The setting data Dla and the setting data D1b generated by the setting part 60 are outputted to the correction section 70.

The setting data D1a and the setting data D1b are both data related to the phase modulation amount and a set voltage for each pixel P, and are both data holding the difference in the phase modulation amount between the pixels P indicated by the phase pattern P1. The setting data Dla and the setting data D1b are each data on the phase modulation amount for each pixel, resulting from shifting the phase modulation amount for the relevant pixel indicated by the phase pattern P1. It is to be noted that the setting data D1a and the setting data D1b may also be each referred to as data indicating a grayscale.

The correction section 70 is configured to correct the setting data D1. The correction section 70 corrects (adjusts) the set voltage for each pixel P indicated by the setting data D1, on the basis of a correspondence between the voltage to be supplied to the pixel P and the phase modulation amount for the pixel P. The correction section 70 may be referred to as a gamma correction section configured to execute gamma correction on the setting data D1.

The storage 30c is configured to store data (correction data) on the correspondence between the phase modulation amount and the voltage to be supplied to the pixel P. The storage 30c holds, for example, the correction data on each subframe as a lookup table (LUT) for each subframe. The correction section 70 controls writing of data into the storage 30c and reading of data from the storage 30c. The correction section 70 performs processing of correcting the setting data DI by reading and referring to the correction data stored in the storage 30c.

In the example illustrated in FIG. 1, the storage 30c stores, as a first LUT, first correction data on a correspondence illustrated in FIG. 3 between the phase modulation amount in the first phase modulation range R1a and the voltage to be supplied to the pixel P. The storage 30b further stores, as a second LUT, second correction data on a correspondence between the phase modulation amount in the second phase modulation range R1b and the voltage to be supplied to the pixel P. The first correction data (the first LUT) and the second correction data (the second LUT) are each correction data usable for the gamma correction, and may also be each referred to as a grayscale table.

For example, the correction section 70 may perform processing of correcting a voltage value for each pixel P indicated by the setting data D1a, on the basis of the first correction data stored in the storage 30c. The correction section 70 corrects the setting data D1a using the first correction data in such a manner that the voltage value for each pixel P indicated by the setting data D1a is a voltage value necessary to obtain the phase modulation amount for each pixel P indicated by the setting data D1a .

The correction section 70 may further perform processing of correcting a voltage value for each pixel P indicated by the setting data D1b, on the basis of the second correction data stored in the storage 30c. The correction section 70 corrects the setting data D1b using the second correction data in such a manner that the voltage value for each pixel P indicated by the setting data D1b is a voltage value necessary to obtain the phase modulation amount for each pixel P indicated by the setting data D1b.

The setting data D1 (in FIG. 1, the setting data D1a and the setting data D1b) corrected by the correction section 70 is outputted to the phase modulation unit 100. The correction section 70 may be considered as outputting the setting data D1 subjected to the gamma correction to the phase modulation unit 100. It is to be noted that the generation section 40 and the correction section 70 may be integrally formed.

The driving section 110 of the phase modulation unit 100 receives the setting data D1 for each subframe generated by the data processing unit 10. The driving section 110 supplies the voltages to the respective pixels P of the phase modulation unit 100 on the basis of respective pieces of the setting data D1 for the subframes sequentially received from the data processing unit 10.

In the example illustrated in FIG. 1, the driving section 110 receives the setting data D1a and the setting data D1b corrected by the correction section 70. For the first subframe, the driving section 110 controls the voltages to be supplied to the respective pixels P of the pixel section 120, in accordance with the voltage value indicated by the setting data D1a, to obtain the difference in the phase modulation amount between the respective pixels indicated by the phase pattern P1, and modulates the phase of the light from the light source 130.

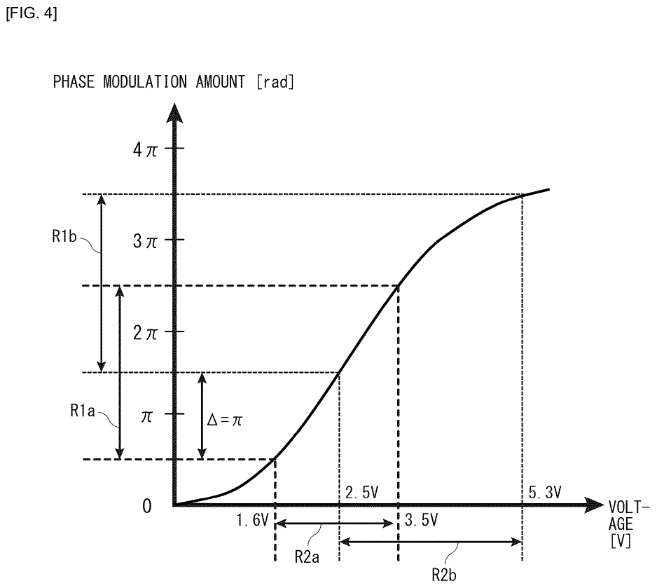

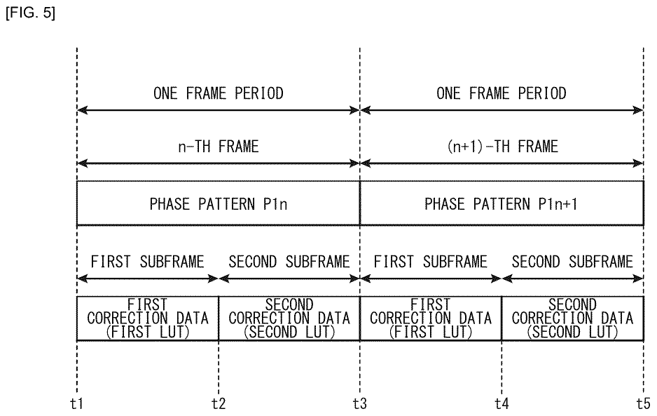

For the second subframe, the driving section 110 further controls the voltages to be supplied to the respective pixels P of the pixel section 120, in accordance with the voltage value indicated by the setting data D1b, to obtain the difference in the phase modulation amount between the respective pixels indicated by the phase pattern P1, and modulates the phase of the light from the light source 130. Hereinafter, description is given of an operation example of the phase modulation apparatus 1 with reference to FIGS. 4 and 5.

FIG. 4 is a graph illustrating an example of the relationship between the phase modulation amount and the voltage applied to the pixel of the phase modulation unit according to the present embodiment. Further, FIG. 5 is a timing chart illustrating an operation example of the phase modulation apparatus according to the present embodiment. In FIG. 5, a phase pattern P1n of an n-th frame, a phase pattern P1n+1 of an (n+1)th frame, the first correction data (the first LUT), and the second correction data (the second LUT) are schematically illustrated on the same time axis.

FIG. 4 illustrates a case where the number of subframes is two. In FIG. 4, a difference in an initial phase amount between the first subframe and the second subframe is π. The first phase modulation range R1a is a set range of the phase modulation amount indicated by the setting data D1a for the first subframe, and is within 0.5 πto 2.5 π. The voltage range R2a is a set range of the applied voltage indicated by the setting data Dla for the first subframe, and is within 1.6 V to 3.5 V.

Further, the second phase modulation range R1b is a set range of the phase modulation amount indicated by the setting data D1b for the second subframe, and is within 1.5 πto 3.5 π. The voltage range R2b is a set range of the applied voltage indicated by the setting data D1b for the second subframe, and is within 2.5 V to 5.3 V. The second phase modulation range R1b is a range resulting from shifting an entirety of the first phase modulation range R1a by J.

In the example illustrated in FIG. 4, the second phase modulation range R1b is a range shifted by π from the first phase modulation range R1a, as described above. A difference between the phase modulation amount for the pixel P in the first subframe and the phase modulation amount for the pixel P in the second subframe is π.

The data processing unit 10 performs the above-described double-speed processing and shift processing using the phase pattern Pln to thereby generate the setting data D1a indicating the voltage range R2a corresponding to the first phase modulation range R1a illustrated in FIG. 4. The data processing unit 10 further generates the setting data D1b indicating the voltage range R2b corresponding to the second phase modulation range R1b illustrated in FIG. 4.

In a period from time t1 to time t2 illustrated in FIG. 5, i.e., in a period of a first subframe of the n-th frame, the phase modulation unit 100 supplies the voltage to each pixel P of the phase modulation unit 100 in accordance with the setting data Dla received from the data processing unit 10, and modulates the phase of the light from the light source 130. In this case, the phase modulation amount for each pixel P is set within a range from 0.5 πto 2.5 π, which is the first phase modulation range R1a.

In a period from the time t2 to time t3, i.e., in a period of a second subframe of the n-th frame, the phase modulation unit 100 supplies the voltage to each pixel P of the phase modulation unit 100 in accordance with the setting data D1b received from the data processing unit 10, and modulates the phase of the light from the light source 130. In this case, the phase modulation amount for each pixel P is set within a range from 1.5 πto 3.5 π, which is the second phase modulation range R1b shifted by π from the first phase modulation range R1a.

In the first subframe and the second subframe of the n-th frame, the phase modulation is performed in accordance with the setting data Dla and the setting data D1b each holding a difference in the phase modulation amount between the pixels indicated by the phase pattern P1n. Accordingly, in the first subframe and the second subframe, the distribution of the phase modulation amounts in accordance with the phase pattern P1n is obtained, and images corresponding to the phase pattern P1n are displayed. It is to be noted that, in a first subframe and a second subframe of the (n+1)-th frame as well, images corresponding to the phase pattern P1n+1 are displayable, similarly to a case of the n-th frame.

As described above, the phase modulation apparatus 1 according to the present embodiment generates, using the phase pattern P1, the plurality of pieces of the setting data D1 indicating the respective phase modulation ranges different from each other, supplies the plurality of pieces of the setting data D1 to the phase modulation unit 100, and modulates the phase of the light. This makes it possible to average speckle (an interference fringe). This makes it possible to reduce speckle noise (interference noise) and improve image quality. In use of coherent light such as laser light, it is possible to suppress a decrease in resolution due to roughness caused in an image.

In the examples illustrated in FIGS. 4 and 5, the phase modulation apparatus 1 modulates the phase of the light in accordance with the setting data D1a indicating the first phase modulation range R1a and with the setting data D1b indicating the second phase modulation range R1b shifted by π from the first phase modulation range R1a. In this case, a bright portion and a dark portion of the speckle noise become opposite between the first subframe and the second subframe, enabling cancellation of the speckle noise. Brightness and darkness of luminance are canceled by temporally superimposing CGH patterns of opposite phases on each other, enabling removal of the speckle noise. This makes it possible to prevent deterioration in image quality caused by the speckle.

Further, the phase modulation apparatus 1 makes it possible to shift a reflecting surface, i.e., a diffraction position, on a screen by changing the optical path length in the phase modulation unit 100 between the subframes, and to temporally average screen noise. This enables a reduction in screen speckle (screen speckle). It is possible to prevent a decrease in image quality of the image.

Furthermore, in the present embodiment, it is not necessary to calculate a plurality of CGH patterns for each frame through the light propagation calculation for use to reduce the speckle noise, enabling a reduction in calculation load. This makes it possible to suppress an increase in size of the phase modulation apparatus 1 and to suppress an increase in manufacturing cost of the phase modulation apparatus 1.

### Workings and Effects

The phase modulation apparatus (the phase modulation apparatus 1) according to the present embodiment includes: the phase modulation unit (the phase modulation unit 100) including the plurality of pixels, the phase modulation unit being configured to modulate the phase of the light from the light source; and the generation section (the generation section 40) configured to generate first data (e.g., the setting data D1a) and second data (e.g., the setting data D1b) on the basis of the phase pattern, the first data (e.g., the setting data D1a) being related to the phase modulation amount for each pixel in the first phase modulation range that is within the range of the phase modulation amount, the second data (e.g., the setting data D1b) being related to the phase modulation amount for each pixel in the second phase modulation range that is within the range of the phase modulation amount. The phase modulation unit is configured to modulate the phase of the light from the light source on the basis of the first data, and modulate the phase of the light from the light source on the basis of the second data.

The phase modulation apparatus 1 according to the present embodiment is configured to modulate the phase of the light from the light source 130 on the basis of the setting data D1a, and modulate the phase of the light from the light source 130 on the basis of the setting data D1b. This makes it possible to suppress the speckle noise. The phase modulation apparatus 1 that makes it possible to suppress a decrease in image quality is achievable.

Next, description is given of modification examples of the present disclosure. Hereinafter, components similar to those in the foregoing embodiment are denoted by the same reference numerals, and description thereof is omitted as appropriate.

### 2. Modification Examples

### 2-1. Modification Example 1

In the foregoing embodiment, the example of setting the first phase modulation range R1a and the second phase modulation range R1b has been described; however, setting of the first phase modulation range R1a and the second phase modulation range R1b is not limited to the above-described example. The second phase modulation range R1b may be a range shifted by an amount of 0.5 π or greater and 1.5 π or less from the first phase modulation range R1a. The difference between the phase modulation amount for the pixel P in the first subframe and the phase modulation amount for the pixel P in the second subframe may be 0.5 π or greater and 1.5 π or less.

Further, the second phase modulation range R1b may be a range shifted by an amount of less than π from the first phase modulation range R1a. The difference between the phase modulation amount for the pixel P in the first subframe and the phase modulation amount for the pixel P in the second subframe may be less than π.

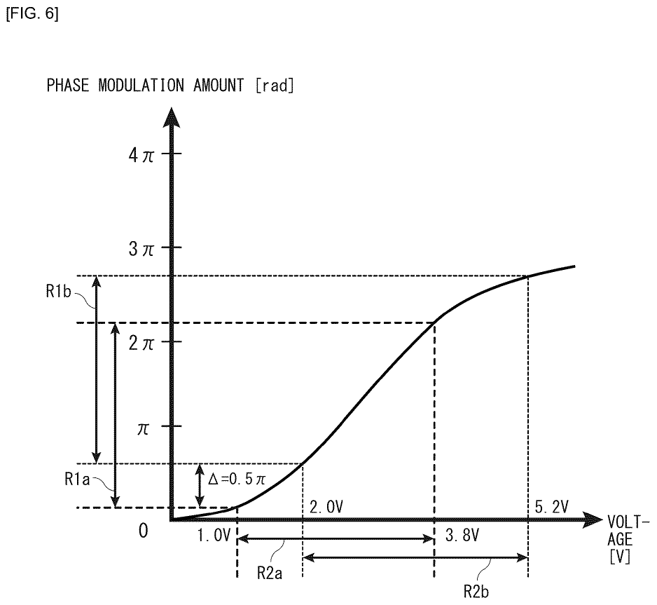

FIG. 6 is a graph illustrating an example of a relationship between the phase modulation amount and the voltage applied to the pixel of a phase modulation unit according to Modification Example 1 of the present disclosure. As in the example illustrated in FIG. 6, the second phase modulation range Rib may be a range shifted by 0.5 π from the first phase modulation range R1a. The difference between the phase modulation amount for the pixel P in the first subframe and the phase modulation amount for the pixel P in the second subframe is 0.5 π.

In the example illustrated in FIG. 6, the difference in the initial phase amount between the first subframe and the second subframe is 0.5 π. The difference in the initial phase amount is 0.5 π or less, enabling a reduction in the phase modulation range necessary for the phase modulation unit 100. This makes it possible to suppress a thickness of the liquid crystal layer necessary for the phase modulation unit 100 and suppress a decrease in response speed. Further, because it is not necessary to use a liquid crystal material having high refractive index anisotropy (Δn) and being easy to decompose due to being unstable with respect to light, heat, moisture, and the like, reliability of the phase modulation unit 100 is improvable.

### 2-2. Modification Example 2

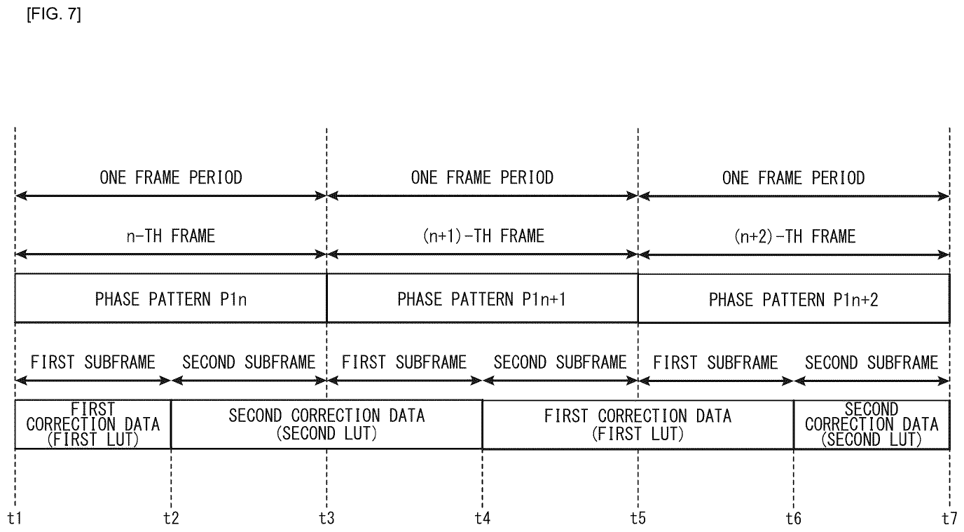

FIG. 7 is a timing chart illustrating an operation example of a phase modulation apparatus according to Modification Example 2. As in the example illustrated in FIG. 7, the phase modulation apparatus 1 may generate the setting data D1 by performing switching between the first correction data (the first LUT) and the second correction data (the second LUT) for each frame.

In the example illustrated in FIG. 7, for example, in the second subframe of the n-th frame, the phase modulation unit 100 performs the phase modulation in accordance with the setting data D1b generated on the basis of the second correction data and the phase pattern P1n of the n-th frame. Further, in the first subframe of the (n+1)-th frame subsequent to the second subframe of the n-th frame, the phase modulation unit 100 may perform the phase modulation in accordance with the setting data D1b generated on the basis of the second correction data and the phase pattern P1n+1 of the (n+1)-th frame.

Further, for example, in the second subframe of the (n+1)-th frame, the phase modulation unit 100 performs the phase modulation in accordance with the setting data D1a generated on the basis of the first correction data and the phase pattern Pn+1 of the (n+1)-th frame. In a first subframe of an (n+2)-th frame subsequent to the second subframe of the (n+1)-th frame, the phase modulation unit 100 may perform the phase modulation in accordance with the setting data D1a generated on the basis of the first correction data and a phase pattern Pn+2 of the (n+2)-th frame.

In the present modification example, switching between the first correction data (the first LUT) and the second correction data (the second LUT) is performed for each frame, making it possible to reduce the number of times of reading the LUT and reduce power consumption. Further, because a timing of switching the phase pattern and a timing of switching the LUT do not coincide with each other, a fluctuation in power supply voltage or the like is suppressible, making it possible to prevent a decrease in response speed of the phase modulation unit 100. This enables prevention of occurrence of a flicker and deterioration in diffraction efficiency.

### 2-3. Modification Example 3

In the foregoing embodiment, the configuration example of the phase modulation unit 100 has been described; however, this is a mere example, and the configuration of the phase modulation unit 100 is not limited to the above-described example. For example, the phase modulation unit 100 may not include the antireflection film 140.

### 2-4. Modification Example 4

In the foregoing embodiment, the example in which the phase modulation is performed by generating the two pieces of the setting data for the subframes has been described as an example. However, three or more pieces of the setting data for subframes may be generated in each frame, and the phase modulation may be performed using the three or more pieces of the setting data for the subframes.

Although the present disclosure has been described with reference to the embodiment and the modification examples, the present technology is not limited to the embodiment and the modification examples described above, and various modifications may be made. For example, although the foregoing modification examples have been described as modification examples of the foregoing embodiment, respective configurations of modification examples may be combined as appropriate.

A phase modulation apparatus according to an embodiment of the present disclosure includes: a phase modulation unit including a plurality of pixels, the phase modulation unit being configured to modulate a phase of light from a light source; and a generation section configured to generate first data and second data on a basis of a phase pattern, the first data being related to a phase modulation amount for each of the pixels in a first phase modulation range that is within a range of the phase modulation amount, the second data being related to the phase modulation amount for each of the pixels in a second phase modulation range that is within the range of the phase modulation amount. The phase modulation unit is configured to modulate the phase of the light from the light source on a basis of the first data, and modulate the phase of the light from the light source on a basis of the second data. Such a configuration makes it possible to suppress speckle noise. This enables achievement of the phase modulation apparatus that makes it possible to suppress a decrease in image quality.

It is to be noted that the effects described herein are merely exemplary and are not limited to the description, and any other effects may be obtained. Further, the present disclosure may have the following configurations.
(1)

A phase modulation apparatus including:
a phase modulation unit including a plurality of pixels, the phase modulation unit being configured to modulate a phase of light from a light source; and
a generation section configured to generate first data and second data on a basis of a phase pattern, the first data being related to a phase modulation amount for each of the pixels in a first phase modulation range that is within a range of the phase modulation amount, the second data being related to the phase modulation amount for each of the pixels in a second phase modulation range that is within the range of the phase modulation amount, in which
the phase modulation unit is configured to
   modulate the phase of the light from the light source on a basis of the first data, and
   modulate the phase of the light from the light source on a basis of the second data.
(2)

The phase modulation apparatus according to (1), in which the generation section is configured to generate the first data and the second data on a basis of the phase pattern of a first frame.
(3)

The phase modulation apparatus according to (1) or (2), in which the phase modulation unit is configured to
modulate the phase of the light from the light source on a basis of the first data in a first subframe of the first frame, and
modulate the phase of the light from the light source on a basis of the second data in a second subframe of the first frame.
(4)

The phase modulation apparatus according to any one of (1) to (3), in which the phase modulation unit is configured to modulate the phase of the light from the light source on a basis of the second data in a subframe subsequent to the second subframe.
(5)

The phase modulation apparatus according to any one of (1) to (4), in which a difference between the phase modulation amount for the pixel in the first subframe and the phase modulation amount for the pixel in the second subframe is 0.5 π0 or greater and 1.5 π or less.
(6)

The phase modulation apparatus according to any one of (1) to (5), in which a difference between the phase modulation amount for the pixel in the first subframe and the phase modulation amount for the pixel in the second subframe is π.
(7)

The phase modulation apparatus according to any one of (1) to (5), in which a difference between the phase modulation amount for the pixel in the first subframe and the phase modulation amount for the pixel in the second subframe is less than π.
(8)

The phase modulation apparatus according to any one of (1) to (7), including a first storage configured to store a first voltage setting value and a second voltage setting value, the first voltage setting value being related to a reference voltage to be supplied to the pixel for the first phase modulation range, the second voltage setting value being related to a reference voltage to be supplied to the pixel for the second phase modulation range.
(9)

The phase modulation apparatus according to (8), in which the generation section is configured to
generate, on a basis of the first voltage setting value, the first data on a voltage to be supplied to the pixel, and
generate, on a basis of the second voltage setting value, the second data on the voltage to be supplied to the pixel.
(10)

The phase modulation apparatus according to any one of (1) to (9), in which the second phase modulation range is a range shifted from the first phase modulation range.
(11)

The phase modulation apparatus according to any one of (1) to (4), in which the second phase modulation range is a range shifted by an amount of 0.5 π or greater and 1.5 π or less from the first phase modulation range.
(12)

The phase modulation apparatus according to any one of (1) to (4), in which the second phase modulation range is a range shifted by π from the first phase modulation range.
(13)

The phase modulation apparatus according to any one of (1) to (4), in which the second phase modulation range is a range shifted by an amount of less than a from the first phase modulation range.
(14)

The phase modulation apparatus according to any one of (1) to (13), including a correction section configured to correct the first data and the second data on a basis of a correspondence between a voltage to be supplied to the pixel and the phase modulation amount for the pixel.
(15)

The phase modulation apparatus according to (14), including a second storage configured to store first correction data and second correction data, the first correction data being related to a correspondence between the phase modulation amount in the first phase modulation range and the voltage to be supplied to the pixel, the second correction data being related to a correspondence between the phase modulation amount in the second phase modulation range and the voltage to be supplied to the pixel.
(16)

The phase modulation apparatus according to (15), in which the correction section is configured to
correct the first data on a basis of the first correction data, and
correct the second data on a basis of the second correction data.
(17)

The phase modulation apparatus according to any one of (14) to (16), in which the phase modulation unit is configured to
modulate the phase of the light from the light source on a basis of the first data corrected by the correction section, and
modulate the phase of the light from the light source on a basis of the second data corrected by the correction section.
(18)

The phase modulation apparatus according to any one of (1) to (17), in which the phase modulation unit includes
a first substrate,
a second substrate opposed to the first substrate, and
a liquid crystal layer provided between the first substrate and the second substrate, the liquid crystal layer including a liquid crystal molecule.

The present application claims the benefit of Japanese Priority Patent Application JP 2022-164784 filed with the Japan Patent Office on Oct. 13, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A phase modulation apparatus comprising:
a phase modulation unit including a plurality of pixels, the phase modulation unit being configured to modulate a phase of light from a light source; and
a generation section configured to generate first data and second data on a basis of a phase pattern, the first data being related to a phase modulation amount for each of the pixels in a first phase modulation range that is within a range of the phase modulation amount, the second data being related to the phase modulation amount for each of the pixels in a second phase modulation range that is within the range of the phase modulation amount, wherein
the phase modulation unit is configured to
modulate the phase of the light from the light source on a basis of the first data, and
modulate the phase of the light from the light source on a basis of the second data.

2. The phase modulation apparatus according to claim 1, wherein the generation section is configured to generate the first data and the second data on a basis of the phase pattern of a first frame.

3. The phase modulation apparatus according to claim 2, wherein the phase modulation unit is configured to
modulate the phase of the light from the light source on a basis of the first data in a first subframe of the first frame, and
modulate the phase of the light from the light source on a basis of the second data in a second subframe of the first frame.

4. The phase modulation apparatus according to claim 3, wherein the phase modulation unit is configured to modulate the phase of the light from the light source on a basis of the second data in a subframe subsequent to the second subframe.

5. The phase modulation apparatus according to claim 3, wherein a difference between the phase modulation amount for the pixel in the first subframe and the phase modulation amount for the pixel in the second subframe is 0.5 π or greater and 1.5 π or less.

6. The phase modulation apparatus according to claim 3, wherein a difference between the phase modulation amount for the pixel in the first subframe and the phase modulation amount for the pixel in the second subframe is π.

7. The phase modulation apparatus according to claim 3, wherein a difference between the phase modulation amount for the pixel in the first subframe and the phase modulation amount for the pixel in the second subframe is less than π.

8. The phase modulation apparatus according to claim 1, comprising a first storage configured to store a first voltage setting value and a second voltage setting value, the first voltage setting value being related to a reference voltage to be supplied to the pixel for the first phase modulation range, the second voltage setting value being related to a reference voltage to be supplied to the pixel for the second phase modulation range.

9. The phase modulation apparatus according to claim 8, wherein the generation section is configured to
generate, on a basis of the first voltage setting value, the first data on a voltage to be supplied to the pixel, and
generate, on a basis of the second voltage setting value, the second data on the voltage to be supplied to the pixel.

10. The phase modulation apparatus according to claim 1, wherein the second phase modulation range is a range shifted from the first phase modulation range.

11. The phase modulation apparatus according to claim 1, wherein the second phase modulation range is a range shifted by an amount of 0.5 π or greater and 1.5 π or less from the first phase modulation range.

12. The phase modulation apparatus according to claim 1, wherein the second phase modulation range is a range shifted by m from the first phase modulation range.

13. The phase modulation apparatus according to claim 1, wherein the second phase modulation range is a range shifted by an amount of less than a from the first phase modulation range.

14. The phase modulation apparatus according to claim 1, comprising a correction section configured to correct the first data and the second data on a basis of a correspondence between a voltage to be supplied to the pixel and the phase modulation amount for the pixel.

15. The phase modulation apparatus according to claim 14, comprising a second storage configured to store first correction data and second correction data, the first correction data being related to a correspondence between the phase modulation amount in the first phase modulation range and the voltage to be supplied to the pixel, the second correction data being related to a correspondence between the phase modulation amount in the second phase modulation range and the voltage to be supplied to the pixel.

16. The phase modulation apparatus according to claim 15, wherein the correction section is configured to
correct the first data on a basis of the first correction data, and
correct the second data on a basis of the second correction data.

17. The phase modulation apparatus according to claim 14, wherein the phase modulation unit is configured to
modulate the phase of the light from the light source on a basis of the first data corrected by the correction section, and
modulate the phase of the light from the light source on a basis of the second data corrected by the correction section.

18. The phase modulation apparatus according to claim 1, wherein the phase modulation unit includes
a first substrate,
a second substrate opposed to the first substrate, and
a liquid crystal layer provided between the first substrate and the second substrate, the liquid crystal layer including a liquid crystal molecule.
